(19) United States
(12) Patent Application Publication
(10) Pub. No.: US 2008/0299906 A1
(43) Pub. Date: Dec. 4, 2008

(54) EMULATING PLAYING APPARATUS OF SIMULATING GAMES

(75) Inventor: Lai suo Li, Shenzhen (CN)

Correspondence Address: ERIC CHAN, 42 PIN OAKS DRIVE, PHOENIXVILLE, PA, 19460, US

(73) Assignee: Topway Electrical Appliance Company, Shenzhen (CN)

(21) Appl. No.: 11/757,417

(22) Filed: Jun. 4, 2007

(51) Int. Cl. H04B 7/00

(52) U.S. Cl. 455/41.2

(57) ABSTRACT

An emulating playing apparatus of simulating games includes a simulating musical instrument, and a receiving member. The simulating musical instrument has controlling keys set thereon and includes a first battery, a first MCU, a first wireless module, and a first antenna. Signals are produced by the controlling keys and transmitted to the first MCU. The first MCU is communicated with the first wireless module which is connected to the first antenna. The receiving member has a port for connecting with a game frame and includes a second battery, a second MCU, a second wireless module, and a second antenna. The second MCU is communicated with the game frame and the second wireless module. The second wireless module is connected to the second antenna. The simulating musical instrument is wirelessly connected to the receiving member via the first wireless module, the first and second antennas, and the second wireless module.

The present invention relates to games, and particularly to an emulating playing apparatus of simulating games.

### BACKGROUND OF THE INVENTION

Currently, a kind of emulating music game runs on many kinds of games stations, such as Guitar Hero of Red Octane Company. The Guitar Hero runs on PS2 stations. In this kind of games, players emulate many kinds of musical instruments via operating joysticks of the stations, to achieve amusing results. However, portions of the games are generally connected via wires, which do not make the players have an immersed sense. Thus, the entertainment would not be chimed in beautifully with the results of simulating.

What is needed is to provide a emulating playing apparatus of simulating games which applies to emulating simulating games on all kinds of musical instruments of all kinds of stations, to chime the entertainment in beautifully with the results of simulating.

### BRIEF SUMMARY OF THE INVENTION

An exemplary emulating playing apparatus of simulating games includes a simulating musical instrument, and a receiving member. The simulating musical instrument has a shape similar to a simulated musical instrument with controlling keys set thereon. The simulating musical instrument includes a first battery, a first MCU, a first wireless module, and a first antenna. Signals are produced by the controlling keys and transmitted to the first MCU. The first MCU is communicated with the first wireless module. The first wireless module is connected to the first antenna. T receiving member has a port for connecting with a game frame and includes a second battery, a second MCU, a second wireless module, and a second antenna. The second MCU is communicated with the game frame and the second wireless module. The second wireless module is connected to the second antenna. The simulating musical instrument is wirelessly connected to the receiving member via the first wireless module, the first and second antennas, and the second wireless module.

Other objects, advantages and novel features of the invention will become more apparent from the following detailed description when taken in conjunction with the accompanying drawings, in which:

### BRIEF DESCRIPTION OF THE DRAWINGS

FIG. 1 is a circuit block diagram of a guitar terminal of an emulating playing apparatus of simulating games in accordance with a preferred embodiment of the present invention; and

FIG. 2 is a circuit block diagram of a receiving terminal of an emulating playing apparatus of simulating games of the preferred embodiment of the present invention.

### DETAILED DESCRIPTION OF THE INVENTION

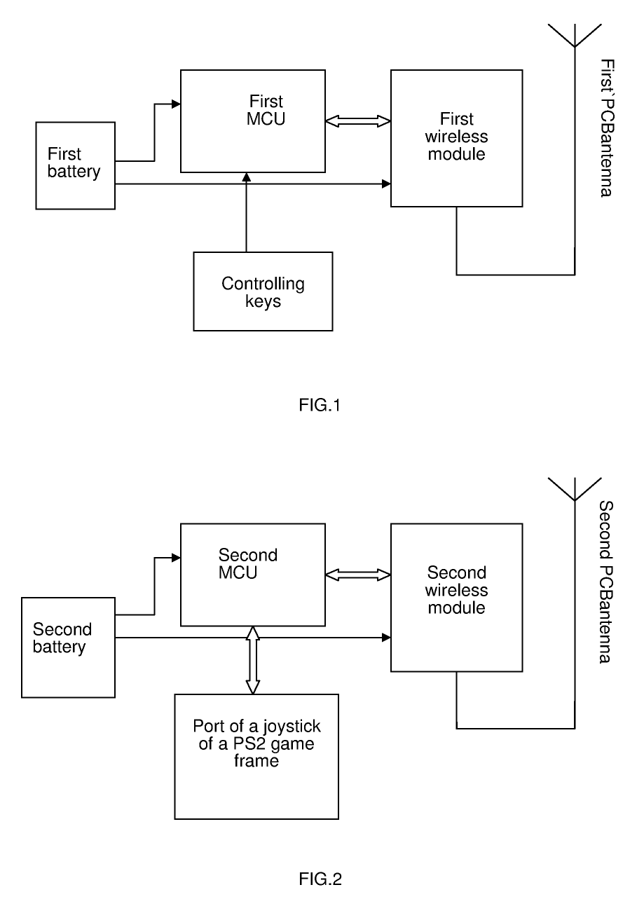

Referring to FIGS. 1 and 2, an emulating playing apparatus of simulating games in accordance with a preferred embodiment of the present invention includes a simulating musical instrument, a receiving member, and a controlling key set on the simulating musical instrument.

The simulating musical instrument has a shape similar to a simulated musical instrument. A plurality of controlling keys that emulates operation forms of the musical instrument is set on the simulating musical instrument. The simulating musical instrument includes a first battery, a first Microprogrammed Control Unit (MCU), a first wireless module, and a first antenna. The controlling keys produce signals and transmit them to the first MCU. The first MCU is communicated with the first wireless module. The first wireless module is electrically connected to the first antenna to communicate with an external.

The receiving member has a port to connect with a game frame and control game software to run. The receiving member includes a second battery, a second MCU, a second wireless module, and a second antenna. The second MCU is communicated with the game frame and the second wireless module. The second wireless module is electrically connected to the second antenna to communicate with an external. The simulating musical instrument is wirelessly connected to the receiving member via the first wireless module, the first and second antennas, and the second wireless module.

The controlling keys of the simulating musical instrument protrude corresponding controlling signals when the controlling keys are operated, such as being pressed, beaten, and et al. The controlling signals are transmitted to the receiving member. The receiving member deals with the controlling signals to control a vocal procedure of the game software of the game frame to give forth sounds of corresponding musical instruments or synchronous interactive motions.

The first wireless module of the simulating musical instrument and the second wireless module of the receiving member are frequency modulation telecommunication modules or 2.4 GHz telecommunication modules. The first antenna of the simulating musical instrument and the second antenna of the receiving member are printed circuit board (PCB) antennas.

The simulating musical instrument can be a simulating guitar, a simulating drum, a simulating bass, a simulating electronic organ, or other simulating musical instruments, according to the kind of the game.

The game frame can be a PS, a PS2, a PS3, an XBOX360, an Xbox, a computer, a Wii, a TV, and so on. The game frame includes all the popular game stations. The receiving member is connected to the game frame via a port of a joystick.

In this embodiment, emulating playing apparatus of simulating games runs on a PS2 station of the Guitar Hero of Red Octane company, to simulate a guitar. The game frame is a PS2 game frame. During a process of playing games, the game frame is connected to a TV or a display screen, to show pictures and sounds of the games.

It is believed that the present invention and its advantages will be understood from the foregoing description, and it will be apparent that various changes may be made thereto without departing from the spirit and scope of the invention or sacrificing all of its material advantages, the example hereinbefore described merely being a preferred or exemplary embodiment of the invention.

What is claimed is:

1. An emulating playing apparatus of simulating games, comprising:
a simulating musical instrument having a shape similar to a simulated musical instrument, a plurality of controlling keys set on the simulating musical instrument, the simulating musical instrument comprising a first battery, a first Microprogrammed Control Unit (MCU), a first wireless module, and a first antenna, signals produced by the controlling keys and transmitted to the first MCU, the first MCU communicated with the first wireless module, the first wireless module connected to the first antenna; and
a receiving member having a port for connecting with a game frame, the receiving member comprising a second battery, a second MCU, a second wireless module, and a second antenna, the second MCU communicated with the game frame and the second wireless module, the second wireless module connected to the second antenna;
wherein the simulating musical instrument is wirelessly connected to the receiving member via the first wireless module, the first and second antennas, and the second wireless module.

2. The emulating playing apparatus of simulating games as claimed in claim 1, wherein the first wireless module of the simulating musical instrument and the second wireless module of the receiving member are frequency modulation telecommunication modules.

3. The emulating playing apparatus of simulating games as claimed in claim 1, wherein the first wireless module of the simulating musical instrument and the second wireless module of the receiving member are 2.4 GHz telecommunication modules.

4. The emulating playing apparatus of simulating games as claimed in claim 1, wherein the first antenna of the simulating musical instrument and the second antenna of the receiving member are printed circuit board (PCB) antennas.

5. The emulating playing apparatus of simulating games as claimed in claim 1, wherein the simulating musical instrument is one of a simulating guitar, a simulating drum, a simulating bass, and a simulating electronic organ.

6. The emulating playing apparatus of simulating games as claimed in claim 1, wherein the game frame is one of a PS, a PS2, a PS3, an XBOX360, an Xbox, a computer, a Wii, and a TV.

7. The emulating playing apparatus of simulating games as claimed in claim 1, wherein the receiving member is connected to the game frame via a port of a joystick.
